(19) United States
(12) Patent Application Publication
(10) Pub. No.: US 2025/0327155 A1
(43) Pub. Date: Oct. 23, 2025

(54) ALLOY FOR MANUFACTURING TOOLS INTENDED FOR MANUFACTURING AERONAUTICAL PARTS MADE OF COMPOSITE MATERIAL

(71) Applicant: APERAM, Luxembourg (LU)

(72) Inventors: Pierre-Louis REYDET, URZY (FR); Fanny JOUVENCEAU, Saint Parize Le Châtel (FR)

(21) Appl. No.: 18/868,070

(22) PCT Filed: May 27, 2022
(86) PCT No.: PCT/IB2022/055009

§ 371 Date: Nov. 21, 2024

(51) Int. Cl. C22C 38/08; B21C 1/00; B22F 5/00; B22F 9/08; B22F 10/28; B33Y 10/00; B33Y 70/00; B33Y 80/00; C22C 38/00; C22C 38/02; C22C 38/04; C22C 38/10; C22C 38/14

(52) U.S. Cl. CPC C22C 38/08; B21C 1/003; B22F 9/082; B22F 10/28; B33Y 10/00; B33Y 70/00; B33Y 80/00; C22C 38/004; C22C 38/005; C22C 38/02; C22C 38/04; C22C 38/10; C22C 38/14; B22F 2005/002; B22F 2301/355

(57) ABSTRACT

The invention relates to an alloy for manufacturing a tool intended for manufacturing aeronautical parts made of composite material, the alloy comprising by weight:

$$\begin{matrix}32.6 \% \leq Ni \leq 38. \% \\ 0.8 \% \leq Co \leq 4.2 \%\end{matrix}$$

Co≥−1.00×Ni %+36.80%, where Ni % denotes the Ni content in weight percent in the alloy; and
Co≤−1.63×Ni %+62.72%, where Ni % denotes the Ni content in weight percent in the alloy,

$$\begin{matrix}1. \% \leq Ti \leq 2. \% \\ 0.001 \% \leq rare earths \leq 0.05 \% \\ 0.1 \% \leq Si \leq 0.35 \% \\ 0.15 \% \leq Mn \leq 0.6 \% \\ 0.005 \% \leq C \leq 0.04 \%\end{matrix}$$

the remainder being iron and impurities resulting from the production process.

The present disclosure relates to an alloy for manufacturing tools, in particular moulds or mould parts, intended for the manufacture of aeronautical parts in composite material.

The search for a trade-off between weight and mechanical properties within the aeronautical industry has led to the production of an increasing number of aeronautical parts, in particular structural parts or functional components such as wings or fuselages, in composite materials. These composite materials generally comprise a polymer matrix within which there are embedded reinforcing fibres. For example, the polymer matrix is formed of a thermosetting resin, in particular an epoxy, polyester, vinyl ester, polyamide or phenol resin. The reinforcing fibres are chosen for example from among glass, carbon, Kevlar, aluminium or titanium fibres. In some cases, the fibres are woven for the purpose of further improving the mechanical properties of the part.

For the production of these parts, the starting material is generally a Prepreg, i.e. a composite in the form of a strip comprising reinforcing fibres embedded in the polymer matrix. The part is manufactured from this starting material using one of the two following methods:
(a) Layering and autoclave curing, comprising the following successive steps:
   a. Depositing the starting material in successive layers on a metal mould of convex or concave shape, to obtain a lay-up on the metal mould,
   b. Vacuum bagging the lay-up to remove air bubbles and compact the lay-up into the greater or lesser complex shapes of the mould,
   c. Curing the polymer matrix of the composite by heat treatment of the assembly comprising the mould and lay-up, in an autoclave under pressure and at temperatures of between 120° C. and 180° C., for several hundred minutes:
(b) Pressure moulding, this method being similar to method (a) but, instead of the autoclave curing step, it comprises a curing step of the composite in a press, by hot pressing the lay-up between a first mould on which the lay-up is applied and a second mould having a cavity matching that of the first mould. Hot pressing is performed at similar temperatures and for similar times to those mentioned for method (a).

The tooling used to produce aeronautical parts in composite material with the above-mentioned methods must therefore ideally have the following properties:
good mechanical strength at curing temperatures of the polymer matrixes and under the numerous heat cycles resulting from reuse of the tooling,
a coefficient of thermal expansion adapted to that of the composite material being used,
dimensional stability,
vacuum tightness.

Additionally, this tooling must allow production at least cost, in particular in terms of manufacturing costs, end weight, manufacturing time, etc.

For the manufacture of parts in composite materials comprising carbon fibres embedded in an epoxy resin matrix, it is considered that the coefficient of thermal expansion of the tooling is adapted to that of the composite being used if the metal alloy, in which the tooling is made, has a coefficient of thermal expansion at between 20° C. and 200° C. of between 2.2×10⁻⁶° C.⁻¹ and 2.9×10⁻⁶° C.⁻¹.

Invar M93 has a coefficient of thermal expansion adapted for the manufacture of such tooling. In addition, it also exhibits advantageous properties for said application in particular in terms of scratch and impact resistance, increased lifetime of the tooling compared with non-metal moulds, the possibility of obtaining machine-welded tooling or mould structures, and possible machining of tooling having a machine-welded structure.

For the purpose of reducing production costs and improving productivity associated with the production tooling intended for the above-mentioned applications, it is sought to produce this tooling using additive manufacturing processes. Additive manufacturing allows rapid, flexible manufacturing of this tooling. It also allows the manufacture of tooling tolerating more heat cycles with limited maintenance.

To further improve productivity, it is sought to reach relatively high deposition rates in additive manufacturing processes, for example deposition rates higher than or equal to about 450 cm³/h.

One manner in which to increase the deposition rate in additive manufacturing is to reduce the time between two successive passes of material deposition, also called inter-pass time in the remainder hereof. The inventors of the present disclosure have ascertained however that when manufacturing test walls via wire-arc additive manufacturing using wire in Invar M93, the reduction in inter-pass time led to collapsing of these walls due to the increase in inter-pass temperatures. In particular the inventors have observed that the wall started to display sagging on and after an inter-pass temperature of 600° C. Said method does not therefore allow the manufacture of parts of satisfactory quality with the targeted productivity rate.

It is one objective of the invention to propose an alloy allowing the additive manufacturing of tools intended for the manufacture of aeronautical parts in composite material, with improved productivity.

For this purpose, the invention relates to an alloy for the manufacture of a tool intended for the manufacture of aeronautical parts in composite material, the alloy comprising by weight:

$$\begin{matrix}32.6 \% \leq Ni \leq 38. \% \\ 0.8 \% \leq Co \leq 4.2 \%\end{matrix}$$

with:
Co≥−1.00×Ni %+36.80%, where Ni % denotes the Ni content in weight percent in the alloy; and
Co≤−1.63×Ni %+62.72%, where Ni % denotes the Ni content in weight percent in the alloy

$$\begin{matrix}1. \% \leq Ti \leq 2. \% \\ 0.001 \% \leq rare earths \leq 0.05 \% \\ 0.1 \% \leq Si \leq 0.35 \% \\ 0.15 \% \leq Mn \leq 0.6 \% \\ 0.005 \% \leq C \leq 0.04 \%\end{matrix}$$

The remainder being iron and impurities resulting from the production process.

Preferably, the impurities resulting from the production process comprise by weight:

$$\begin{matrix}Ca \leq 0.0015 \% \\ Mg \leq 0.0035 \% \\ Al \leq 0.0085 \% \\ O \leq 0.0025 \% \\ S \leq 0.0035 \% \\ P \leq 0.01 \% \\ B \leq 0.0005 \% \\ Mo \leq 0.1 \% \\ Cr \leq 0.1 \% \\ Cu \leq 0.1 \% \\ Nb \leq 0.1 \% \\ V \leq 0.1 \%\end{matrix}$$

Preferably, the rare earths comprise yttrium, cerium, lanthanum, neodymium, praseodymium, or mixtures thereof.

The invention also relates to a filler wire made of the alloy as defined above.

The invention also relates to a method for manufacturing a filler wire as defined above, the method comprising the following steps:
providing a semi-finished product in an alloy as defined above;
hot processing this semi-finished product to form an intermediate wire; and
processing the intermediate wire to a filler wire having a smaller diameter than the intermediate wire, said processing comprising a wire-drawing step.

The invention also relates to the use of the alloy as defined above to manufacture at least part of a tool intended for the manufacture of an aeronautical part in composite material.

The invention also relates to a part or portion of a part, made of an alloy as defined above.

According to particular features of the part or portion of a part:
said part or portion of a part is obtained by metal additive manufacturing;
the part is a tool, in particular a mould, intended for the manufacture of an aeronautical part in composite material.

The invention also relates to a method for manufacturing a part or portion of a part, comprising a step of producing said part or portion of a part via a metal additive manufacturing process using, as filler material, a filler wire made of the alloy as defined above and/or a powder of the alloy as defined above.

According to particular features of the manufacturing method:
the additive manufacturing process is chosen from among wire-arc, wire-Laser, wire-electron beam and a hybrid additive manufacturing method combining the technologies of wire-arc and powder-Laser or wire-arc and wire-Laser.

The invention also relates to the use of the filler wire as defined above as filler wire in a metal additive manufacturing process.

The invention also relates to a metal powder made of an alloy as defined above.

The invention also relates to a method for manufacturing a metal powder as defined above, said method comprising a step of providing a filler wire as defined above and a plasma atomization step of this filler wire to obtain the metal powder.

The invention will be better understood on reading the following description given solely as an example and with reference to the appended drawings in which:

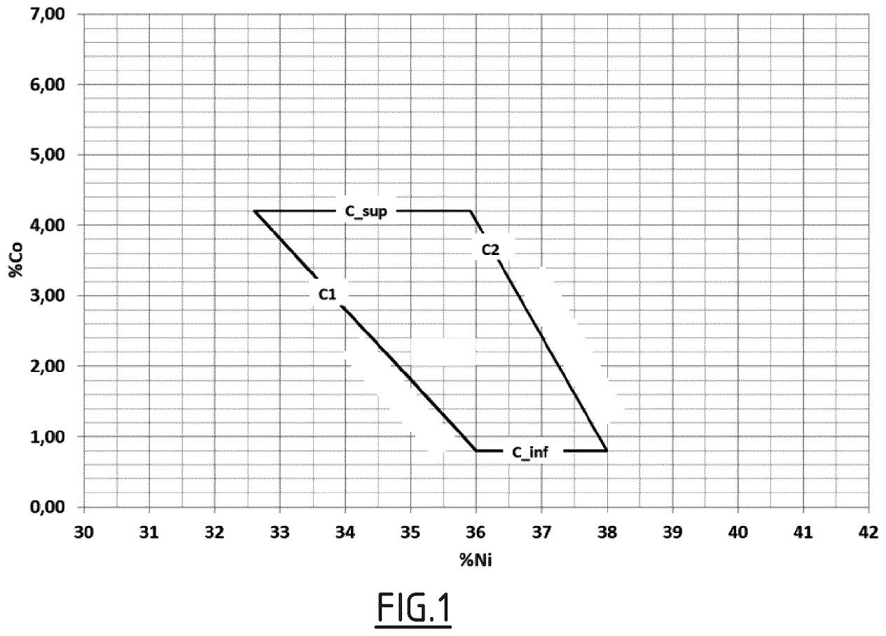

FIG. 1 is a graph illustrating the range of permitted contents of cobalt in the alloy of the invention as a function of the nickel content of the alloy, the contents being expressed in weight percent; and

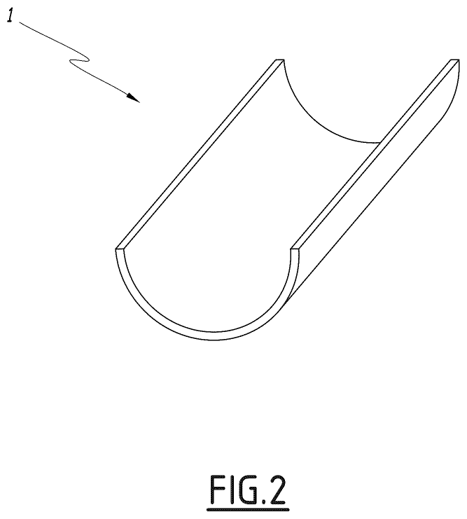

FIG. 2 is a schematic perspective view of a part obtained by additive manufacturing according to the invention.

The alloy of the invention comprises, by weight:

$$\begin{matrix}32.6 \% \leq Ni \leq 38. \% \\ 0.8 \% \leq Co \leq 4.2 \%\end{matrix}$$

Co≥−1.00×Ni %+36.80%, where Ni % denotes the Ni content in weight percent in the alloy; and
Co≤−1.63×Ni %+62.72%, where Ni % denotes the Ni content in weight percent in the alloy

$$\begin{matrix}1. \% \leq Ti \leq 2. \% \\ 0.001 \% \leq rare earths \leq 0.05 \% \\ 0.1 \% \leq Si \leq 0.35 \% \\ 0.15 \% \leq Mn \leq 0.6 \% \\ 0.005 \% \leq C \leq 0.04 \%\end{matrix}$$

the remainder being iron and impurities resulting from the production process.

By impurities resulting from the production process, it is meant elements which are contained in the raw material used to prepare the alloy or which derive from equipment used for this preparation e.g. furnace refractories. These residual elements do not have any metallurgical impact on the alloy.

The impurities resulting from the production process particularly comprise, by weight:

$$\begin{matrix}Ca \leq 0.0015 \% \\ Mg \leq 0.0035 \% \\ Al \leq 0.0085 \% \\ O \leq 0.0025 \% \\ S \leq 0.0035 \% \\ P \leq 0.01 \% \\ B \leq 0.0005 \% \\ Mo \leq 0.1 \% \\ Cr \leq 0.1 \% \\ Cu \leq 0.1 \% \\ Nb \leq 0.1 \% \\ V \leq 0.1 \%\end{matrix}$$

More particularly, the contents of sulphur, phosphorus, oxygen, boron, magnesium, aluminium and calcium are preferably limited to the upper limits mentioned above to prevent degraded weldability of the alloy. In particular, the limiting of the contents of magnesium, aluminium, calcium and oxygen to the contents specified above prevents degradation of the stability of the electric arc in arc mode, in particular in additive manufacturing. Limiting of the contents of sulphur, phosphorus and boron to the above-mentioned contents prevents degradation of resistance to hot cracking of the parts made of this alloy.

Finally, the contents of molybdenum, chromium, copper, niobium and vanadium are preferably limited to the above-mentioned contents to prevent degradation of the coefficient of thermal expansion of the alloy.

The above-described alloy is an alloy of Invar type.

The alloy of the invention is an austenitic alloy at a temperature equal to ambient temperature (about 20° C.).

The mean coefficient of thermal expansion α_{20° C._200° C.} between 20° C. and 200° C. of the alloy of the invention is between 2.2×10⁻⁶° C.⁻¹ and 2.9×10⁻⁶° C.⁻¹. A mean coefficient of thermal expansion between 20° C. and 200° C. lying within this range is advantageous in particular when the alloy of the invention is used to produce tooling intended for the manufacture of aeronautical parts in composite material, and in particular comprising an epoxy resin matrix within which reinforcing fibres are embedded, according to the above-indicated methods. Said coefficient can ensure compatibility in terms of thermal expansion between the tooling made of the alloy described above and the composite material used to manufacture the aeronautical part. Any lack of compatibility between the mean coefficients of thermal expansion of the tooling and the part risks subjecting the part to distortions or deformations during manufacture due to expansion of the part relative to the tooling, or risks creating stresses within the part on cooling after the curing treatment. In addition, the composite material may become detached from the tooling during heating, generating drips and leaving fibres uncovered, leading to a faulty part. Therefore, with the alloy of the invention it is possible to obtain parts in composite material for aeronautical applications, in particular in composite material comprising an epoxy resin matrix in which carbon reinforcing fibres are embedded, the parts fulfilling theoretical dimensions and having fibres fully protected by the resin and free of residual stresses.

Also, a mean coefficient of thermal expansion α_{20° C._200° C.} between 20° C. and 200° C. of between 2.2×10⁻⁶° C.⁻¹ and 2.9×10⁻⁶° C.⁻¹ ensures good dimensional stability

Additionally, the alloy of the invention allows the obtaining of parts, such as tooling or parts of tooling, to produce aeronautical parts, having:
good mechanical strength at the curing temperatures of polymer matrices and under numerous heat cycles resulting from reuse of the tooling; and
vacuum tightness.

In the alloy of the invention, the nickel content is between 32.6 weight % and 38.0 weight %. If the nickel content is lower than 32.6 weight %, there is a risk of martensitic transformation at temperatures close to ambient temperature, and resulting risk that the alloy will no longer be austenitic at ambient temperature which would be detrimental to the dimensional stability thereof. If the nickel content is higher than 38.0 weight %, the coefficient of thermal expansion of the alloy will become too high and the dimensional stability of the alloy will be jeopardized.

In the invention, the cobalt content is between 0.80 weight % and 4.20 weight % and in addition fulfills the following conditions: Co≥−1.00×Ni %+36.80% and Co≤−1.63×Ni %+62.72%. In these inequations. Ni % denotes the nickel content by weight in the alloy, and Co designates the cobalt content in weight % in the alloy.

The range of permitted contents for cobalt expressed in weight percent, as a function of the nickel content expressed in weight percent is illustrated in FIG. 1. In this Figure:
the line C_sup has the equation: Co=4.20%
the line C_inf has the equation: Co=0.80%
the line C1 has the equation: Co=−1.00×Ni %+36.80%
the line C2 has the equation: Co=−1.63×Ni %+62.72%.

In this Figure, the range of the invention corresponds to the range delimited by the lines C1, C2, C_inf and C_sup.

A cobalt content lying within this range allows the obtaining of a mean coefficient of thermal expansion between 20° C. and 200° C. of between 2.2×10⁻⁶° C.⁻¹ and 2.9×1⁻⁶° C.⁻¹.

If the cobalt content is higher than 4.20 weight %, corresponding to cobalt contents lying above the line C_sup in FIG. 1, the mean coefficient of thermal expansion between 20° C. and 200° C. risks being below the lower limit of 2.2×10⁻⁶° C.⁻¹ desired for the above-mentioned application, namely the manufacture of tools intended for the manufacture of aeronautical parts. Also, in this case, there is an increased risk of martensitic transformation under work hardening, and in particular via plastic deformation, e.g. during wire-drawing, which would increase the cost price of manufacturing methods via wire-drawing and require intermediate austenitic annealing to intermediate wire diameters e.g. of approximately 2 mm.

If the cobalt content is lower than 0.80 weight %, corresponding to cobalt contents below the line C_inf in FIG. 1, the mean coefficient of thermal expansion between 20° C. and 200° C. risks being higher than the upper limit of 2.9×10⁻⁶° C.⁻¹ desired for the above-mentioned application.

If the cobalt content is below the line C1, i.e. when Co≤−1.00×Ni %+36.80%, the mean coefficient of thermal expansion between 20° C. and 200° C. risks being higher than the upper limit of 2.9×10⁻⁶° C.⁻¹ desired for the above-mentioned application.

If the cobalt content lies above the line C2, i.e. when Co>−1.63×Ni %+62.72%, the mean coefficient of thermal expansion between 20° C. and 200° C. risks being higher than the upper limit of 2.9×10⁻⁶° C.⁻¹ desired for the above-mentioned application.

In the alloy of the invention, the titanium content of between 1.0 weight % and 2.0 weight % allows the obtaining of good resistance to collapse of the melt pool during additive manufacturing of parts made in the alloy of the invention via wire-arc additive-manufacturing, and therefore particularly prevents the formation of drips in the part.

If the titanium content is below 1.0 weight % the resistance of the melt pool to collapse during the additive manufacture of parts in the alloy of the invention, in particular via wire-arc additive manufacturing, is insufficient and a high production rate, in particular a deposition rate higher than or equal to 450 cm³/h, generates undesirable drips.

If the titanium content is higher than 2.0 weight %, the mean coefficient of thermal expansion between 20° C. and 200° C. risks being higher than the upper limit of 2.9×1⁻⁶° C.⁻¹ desired for the above-mentioned application.

In the alloy of the invention, the content of rare earths is between 0.0010% and 0.0500%. The addition of rare earths at the indicated contents allows reinforcing of the role of titanium, thereby improving resistance to collapse of the melt pool during the additive manufacture of parts in the alloy of the invention, in particular via wire-arc additive manufacturing.

The rare earths are particularly chosen from among yttrium, cerium, lanthanum, neodymium and praseodymium or mixtures thereof.

In one example, the rare earths are yttrium.

In one variant, the rare earths comprise a mixture of cerium and lanthanum, and are derived for example from Mischmetal. In particular, the rare earths are a mixture of cerium and lanthanum.

In the alloy of the invention, silicon, manganese, and carbon are added to desulfurize and deoxidize the alloy. The contents thereof by weight are chosen in the following ranges:

$$\begin{matrix}0.1 \% \leq Si \leq 0.35 \% \\ 0.15 \% \leq Mn \leq 0.6 \% \\ 0.005 \% \leq C \leq 0.04 \%\end{matrix}$$

If the contents of silicon and/or manganese are higher than the limits given above, the coefficient of thermal expansion risks being higher than the upper limit of 2.9×10⁻⁶° C.⁻¹ desired for the above-mentioned application.

A carbon content higher than 0.04% risks leading to issues of hot cracking on solidification, due to the precipitation of titanium carbides, and hence to poor behaviour during solidification of weld metal.

The alloy of the invention is advantageous. It allows the production, via additive-manufacturing, of good quality tooling or parts of tooling intended for the manufacture of aeronautical parts in composite material, particularly comprising an epoxy resin matrix in which carbon fibres are embedded as reinforcing fibres, and in a manner that is simple and flexible with high productivity. The alloy has the desired properties for said above-mentioned alloys and in particular a mean coefficient of thermal expansion between 20° C. and 100° C. of between 2.2×10⁻⁶° C.⁻¹ and 2.9×10⁻⁶° C.⁻¹, resulting in satisfactory compatibility between the tooling and the part to be manufactured, and good resistance to collapse of the melt pool during additive-manufacturing of the parts, allowing the production of good quality parts with a high productivity rate, in particular a deposition rate higher than or equal to 450 cm³/h,

The alloy of the invention can be prepared with any adapted method known to persons skilled in the art.

For example, at a first step, the starting materials are placed in an electric arc furnace. These starting materials are melted in the electric arc furnace, and vacuum oxygen decarburization (VOD) using a new VOD vessel, is carried out with usual methods to obtain:
decarburization via oxygen injection and vacuum pumping (a few mbar);
deoxidation and desulfurization on lime-based slag; and
adjustment of the silicon content.

The invention also relates to a filler wire made of an alloy having a composition as defined above.

Said filler wire is adapted in particular for use as filler wire in a metal additive manufacturing process.

The additive manufacturing process is for example a process of additive manufacturing using an electric arc, a laser beam and/or an electron beam as source of energy to obtain fusion of the filler wire.

The additive manufacturing process is in particular an additive manufacturing process known as Directed Energy Deposition. In this process, the filler material is deposited in particular via a nozzle and immediately fused by concentrated thermal energy, in particular by a laser beam, electron beam and/or electric arc.

For example, the additive manufacturing process is a wire-arc (Wire Arc Additive Manufacturing or WAAM process), wire-Laser or electron beam-wire (Electron Beam Free Form Fabrication or Electron beam additive manufacturing) process or a hybrid additive manufacturing process combining the technologies of wire-arc and powder-Laser or wire-arc and wire-Laser.

For a hybrid wire-arc and powder-Laser process, the powder used has the same composition as the wire.

Said powder, having a particle size after screening of between 20 μm and 150 μm, is obtained for example from a filler wire of the invention using plasma atomization technology. Preferably, the filler wire used to manufacture the powder has a diameter of about 3 mm.

The particle size of the powders is determined in particular with the following method. The batches of powders are separated into several particle size distributions using a stainless steel screen under ultrasonic vibration. Analysis of the particle size distribution of the screened powders is carried out according to standard ASTM B214-07. Screening allows 5 class sizes to be obtained: <20 μm-20 μm á 45 μm-45 μm to 75 μm-75 μm to 105 μm->105 μm.

The technology of plasma atomization to produce a powder from a wire is known per se and will therefore not be described in more detail.

The invention also relates to a method for manufacturing a filler wire in an alloy as described above.

This method, at a first step, comprises the providing of a semi-finished product made of this alloy. The alloy is either cast into ingots or directly cast in the form of billets by continuous casting, particularly of rotary type. The semi-finished products obtained after this step are therefore advantageously ingots or billets and have a diameter for example of between 130 and 230 mm, and more particularly of about 150 mm.

The semi-finished products are transformed by hot processing to form an intermediate wire.

In particular, at this hot processing step, the semi-finished products, in particular ingots or billets, are reheated in a gas furnace, for example up to a temperature of between 1180° C. and 1220° C.

They are next subjected to hot roughing to reduce their cross-section, imparting thereto a square cross-section for example with sides of about 100 mm to 200 mm. A semi-finished product of reduced cross-section is thereby obtained. The length of this semi-finished product of reduced cross-section is between 10 m and 20 m.

The semi-finished products of reduced cross-section are again hot processed at a temperature of between 950° C. and 1150° C., to obtain the intermediate wire. The intermediate wire can in particular be a wire rod. It has a diameter for example of between 5 mm and 21 mm, in particular of about 5.5 mm. Advantageously, at this step, the intermediate wire is produced by hot rolling on a wire-rod mill.

Optionally, the intermediate wire is afterwards subjected to solution annealing after heat treatment in a gas furnace at a temperature of between 1150° C. and 1220° C. for a time of between 60 minutes and 120 minutes.

The intermediate wire is then stripped and wound on a spool.

Optionally, the intermediate wire thus obtained is drawn on a wire-drawing installation of known type to obtain the filler wire. This filler wire has a smaller diameter than the starting wire. In particular, it has a diameter of between 0.5 mm and 3.5 mm. Advantageously, it is between 0.8 mm and 2.4 mm.

The wire-drawing step, depending on the final diameter to be reached, comprises one or more wire-drawing passes preferably with annealing between two successive wire-drawing passes. This annealing is performed for example in-line under a reducing atmosphere at a temperature in the region of 1150° C.

The wire-drawing step is preferably followed by cleaning of the surface of the drawn wire, and traverse winding of the wire on a spool.

The wire-drawing passes are cold passes.

Any other method known to skilled persons for preparing the alloy of the invention and for manufacturing end products in this alloy can be used for this purpose.

The invention also relates to a method for manufacturing a part or portion of a part 1 made of an alloy as described above, as schematically illustrated in FIG. 2, comprising:
providing a filler wire in said alloy; and
manufacturing the part 1 or portion of part via a metal additive manufacturing process using, as filler material, a filler wire made of the alloy as described above and/or a powder of the alloy as described above.

The part 1 or portion of part is preferably a tool or part of tooling intended to be used for the manufacture of aeronautical parts made of composite materials, the composite material particularly comprising an epoxy resin matrix in which reinforcing fibres are embedded in the form of carbon fibres. In particular the part 1 is a mould or part of a mould intended to be used for the manufacture of aeronautical parts made of composite materials, the composite material particularly comprising an epoxy resin matrix in which reinforcing fibres are embedded in the form of carbon fibres. For example, the part 1 defines a moulding surface of a tool intended to be used for the manufacture of aeronautical parts made of composite materials, and optionally also comprises a supporting structure of said moulding surface.

The additive manufacturing process is for example additive manufacturing using an electric arc, a laser beam and/or an electron beam as energy source to obtain fusion of the filler material.

In particular, the additive manufacturing process is an additive manufacturing process known as Directed Energy Deposition. With this method, the filler material is deposited by a nozzle in particular and immediately fused by concentrated thermal energy, in particular a laser beam, electron beam and/or electric arc.

For example, the additive manufacturing process is a wire-arc, wire-Laser or electron beam-wire (Electron Beam Free Form Fabrication or Electron beam additive manufacturing) process or a hybrid additive manufacturing process combining the technologies of wire-arc and powder-Laser or wire-arc and wire-Laser.

In the case of a hybrid additive manufacturing process combining wire-arc and powder-Laser or wire-arc and wire-Laser technologies, the powder and filler wire are made of the alloy as described above.

The additive manufacturing processes mentioned above are known per se and will not be described in detail.

However, in the invention, the additive manufacturing process comprises several passes, each pass corresponding to the formation of a layer of the part 1 or portion of part to be produced, the time between two successive passes being defined by the minimum time needed for the tool, in particular the filler material fusion tool, for example the laser beam, electron beam and/or electric arc, to return to the start of the deposition zone.

Having regard to the above-described advantageous properties of the alloy of the invention, this manufacturing method allows the flexible production of high quality parts 1 or portions of parts with high productivity, and in particular with a deposition rate higher than or equal to 450 cm³/h.

If the filler material comprises a powder, in particular in a hybrid wire-arc and powder-Laser process, prior to manufacture of the part 1 or portion of part, the method also comprises a step of providing a powder of the alloy as described above. This powder, having a particle size after screening of between 20 μm and 150 μm, is manufactured for example by plasma atomization from a wire made of the alloy as described above, the wire in particular having a diameter of about 3 mm.

The plasma atomization process is known per se and will not be described in detail.

The invention also relates to a part 1 or portion of a part made of the alloy as described above, obtained by metal additive manufacturing.

The part 1 or portion of a part is preferably a tool or part of tooling intended to be used for the manufacture or aeronautical parts made of composite materials, the composite material particularly comprising an epoxy resin matrix in which reinforcing fibres are embedded in the form of carbon fibres. In particular, the part 1 is a mould or part of a mould intended to be used for the manufacture of aeronautical parts made of composite materials, the composite material particularly comprising an epoxy resin matrix in which reinforcing fibres are embedded in the form of carbon fibres. For example, the part 1 defines a moulding surface of a tool intended to be used for the manufacture of aeronautical parts made of composite materials and optionally also comprises a supporting structure of said moulding surface.

The metal additive manufacturing process, as filler material, particularly uses a filler wire made of the alloy as described above and/or a powder made of the alloy as described above.

For example, the additive manufacturing process is an additive manufacturing process using an electric arc, a laser beam, and/or an electron beam as energy source for fusion of the filler material.

In particular, the additive manufacturing process is a method known as Directed Energy Deposition. With this method, the filler material is deposited by a nozzle in particular and is immediately fused by concentrated thermal energy, in particular by a laser beam, electron beam and/or electric arc.

For example, the additive manufacturing process is a wire-arc, wire-Laser or electron beam-wire (Electron Beam Free Form Fabrication or Electron beam additive manufacturing) process or a hybrid additive manufacturing process combining the technologies of wire-arc and powder-Laser or wire-arc and wire-Laser.

If a hybrid additive manufacturing process is used combining the technologies of wire-arc and powder-Laser, or wire-arc and wire-Laser, the powder and filler wire are made of the alloy as described above.

A part 1 or portion of a part obtained with a metal additive manufacturing process is as-solidified. It therefore has a solidification microstructure typical of the nickel alloy under consideration, said microstructure typically comprising columnar dendrites obtained by epitaxial growth on each other, and the orientation of which is dependent on the width and height of the fabricated metal wall. Also, a part 1 obtained with an additive manufacturing process, on account of this process, exhibits a succession of superimposed solidification layers. Each layer, obtained by solidification of deposited fused metal drops, melts the skin of the preceding layer to generate metallurgical continuity, and thus reheats the rest of the lower layers. The reheating temperature is lower the further the layer under consideration lies from the zone being fused and solidified. This particular microstructure can be seen under metallographic observation on metallographic sections of the parts 1.

A part 1 or portion of a part obtained with a metal additive manufacturing process can therefore be distinguished from parts obtained with other methods, and in particular parts obtained by conventional metallurgy methods which produce a recrystallized structure with homogeneous grains.

### Tests

The inventors prepared, under a vacuum in the laboratory, alloys having compositions such as defined above, and comparative alloys having compositions differing from those of the above-described composition, these alloys were then cast in the laboratory to obtain frustoconical ingots having a diameter of 120 mm at the base of the cone and 60 mm at the tip of the cone. The ingots obtained were hot forged to obtain bars 100 mm in diameter and 500 mm in length which were surface machined to remove calamine and forged with a rotary forging machine marketed by GFM to produce bars 30 mm in diameter and length of 3 m. These bars were cold drawn to produce a wire having a diameter of 5.5 mm and length of 15 metres. The cold drawing step comprised a plurality of successive drawing operations with recrystallization heat treatments at a temperature of 1000° C. for one hour between two successive drawing operations. After cold drawing, the wire was annealed at a temperature of 1150° C. for one hour in a gas furnace, stripped and finally drawn on an industrial wire-drawing machine to produce a laboratory filler wire 1.2 mm in diameter wound on spools of 15 kg.

This production method is conventionally used to produce a filler wire in the laboratory, and allows a filler wire to be obtained having the same composition, surface cleanliness and utilisation aptitude as a filler wire obtained with the method described previously for manufacture of the filler wire.

The alloy compositions of each of the filler wires obtained are given in Table 1 below.

TABLE 1
Composition of filler wires

| | | | | | | | | | Co ≤ −1.63 × | Co ≥ −1.00 × |
|---|---|---|---|---|---|---|---|---|---|---|
| Contents in weight % | | | | | | | | | Ni % + | Ni % + |
| No | Fe | Ni | Co | Ti | Ce + La | Si | Mn | C | 62.72%? | 36.80%? |
| 1 | remainder | 35.9 | 2.1 | — | — | 0.15 | 0.20 | 0.007 | yes | yes |
| 2 | remainder | 36.0 | 2.1 | 0.84 | 0.0004 | 0.15 | 0.20 | 0.008 | yes | yes |
| 3 | remainder | 36.1 | 2.0 | 1.05 | 0.0005 | 0.14 | 0.20 | 0.008 | yes | yes |
| 4 | remainder | 35.9 | 2.0 | 1.05 | 0.0008 | 0.15 | 0.18 | 0.008 | yes | yes |
| 5 | remainder | 36.1 | 2.0 | 1.06 | 0.0015 | 0.16 | 0.18 | 0.008 | yes | yes |
| 6 | remainder | 36.2 | 1.9 | 1.48 | 0.0049 | 0.15 | 0.18 | 0.009 | yes | yes |
| 7 | remainder | 35.8 | 2.1 | 1.59 | 0.0151 | 0.15 | 0.19 | 0.009 | yes | yes |
| 8 | remainder | 36.1 | 2.0 | 1.78 | 0.0248 | 0.14 | 0.19 | 0.009 | yes | yes |
| 9 | remainder | 35.9 | 2.0 | 2.51 | 0.0049 | 0.14 | 0.19 | 0.009 | yes | yes |
| 10 | remainder | 36.2 | 0.3 | 1.63 | 0.0050 | 0.14 | 0.22 | 0.008 | yes | no |
| 11 | remainder | 34.9 | 1.0 | 1.66 | 0.0048 | 0.14 | 0.22 | 0.007 | yes | no |
| 12 | remainder | 36.1 | 1.0 | 1.65 | 0.0051 | 0.15 | 0.21 | 0.010 | yes | yes |
| 13 | remainder | 37.3 | 0.9 | 1.65 | 0.0052 | 0.14 | 0.21 | 0.010 | yes | yes |
| 14 | remainder | 34.0 | 2.1 | 1.66 | 0.0049 | 1.60 | 0.21 | 0.010 | yes | no |
| 15 | remainder | 36.1 | 2.0 | 1.66 | 0.0048 | 0.16 | 0.21 | 0.011 | yes | yes |
| 16 | remainder | 38.0 | 1.9 | 1.67 | 0.0050 | 0.16 | 0.22 | 0.009 | no | yes |
| 17 | remainder | 34.9 | 3.1 | 1.64 | 0.0050 | 0.14 | 0.19 | 0.009 | yes | yes |
| 18 | remainder | 32.2 | 4.0 | 1.66 | 0.0050 | 0.14 | 0.19 | 0.009 | yes | no |
| 19 | remainder | 33.3 | 4.0 | 1.66 | 0.0049 | 0.14 | 0.18 | 0.008 | yes | yes |
| 20 | remainder | 35.7 | 4.1 | 1.64 | 0.0051 | 0.14 | 0.20 | 0.008 | yes | yes |
| 21 | remainder | 37.0 | 3.9 | 1.66 | 0.0051 | 0.15 | 0.20 | 0.010 | no | yes |
| 22 | remainder | 33.9 | 5.0 | 1.67 | 0.0050 | 0.15 | 0.20 | 0.010 | yes | yes |
| Invar | remainder | 36.1 | — | — | — | 0.15 | 0.35 | 0.032 | yes | yes |
| M93 | | | | | | | | | | |

In Table 1 above, the alloys not having compositions of the invention are underlined.

In this Table, «—» means that the element under consideration is contained at the most in trace amounts.

In all the alloys, the remainder is iron and impurities resulting from the production process.

Finally, from these wires, the inventors fabricated walls with a wire-arc additive manufacturing process using a Fronius TPS500i welding station and Yaskawa MH24 robot, under the following manufacturing conditions:
Gas: Argon+2.5% CO₂; Flow rate 18 L/min
Process: CMT_Fronius
Synergy: INVAR WAAM
Wire feed rate: 8.6 m/min
Weld speed: 30 cm/min
Arc correction: −1.6
Dynamic correction: 6.2
Single weave: amplitude 6 mm; frequency 2 Hz, halts at spots 1 and 3 of 0.4 s
Pause time between passes: 240 s
Pass increment: 2.5 mm
Deposition rate: 580 cm³/h.

The fabricated walls obtained had a length of 150 mm, width of 150 mm and height of 70 mm.

For each alloy, the inventors determined the number of drips occurring during manufacturing of the wall, and the mean coefficient of thermal expansion of the alloy between 20° C. and 200° C.

The number of drips was visually observed on the walls during manufacturing.

The mean coefficient of thermal expansion between 20° C. and 200° C. was measured as follows. Expansion of the alloys ΔL was measured on heating between 20° C. and 200° C., and the mean coefficient of thermal expansion α[20° C._200° C.] between 20° C. and 200° C. was calculated using the expression:

$$α [ 20 ° C . \_ 200 ° C . ] = \frac{1}{{L}_{0}} \times \frac{Δ L}{Δ T} ,$$

where ΔT=200° C.-2° C. and L₀ is the initial length of the test piece (50 mm).

| | Mean expansion between | Number of drips |
|---|---|---|
| | 20° C. and 200° C. | during wall |
| No | (10⁻⁶° C.⁻¹) | manufacturing |
| 1 | 2.1 | 7 |
| 2 | 2.3 | 5 |
| 3 | 2.3 | 3 |
| 4 | 2.5 | 1 |
| 5 | 2.6 | 0 |
| 6 | 2.6 | 0 |
| 7 | 2.7 | 0 |
| 8 | 2.8 | 0 |
| 9 | 3.3 | 0 |
| 10 | 3.2 | 0 |
| 11 | 3.1 | 0 |
| 12 | 2.8 | 0 |
| 13 | 2.7 | 0 |
| 14 | 3.3 | 0 |
| 15 | 2.7 | 0 |
| 16 | 3.1 | 0 |
| 17 | 2.4 | 0 |
| 18 | 3.1 | 0 |
| 19 | 2.8 | 0 |
| 20 | 2.5 | 0 |
| 21 | 3.5 | 0 |
| 22 | 2.0 | 0 |
| Invar M93 | 2.5 | 6 |

### Table 2: Results of Wall Manufacturing Tests Using the Alloys in Table 1

In Table 2 above, the test walls not conforming to the invention are underlined.

The tests performed by the inventors showed that the walls fabricated from the filler wire in Invar M93 exhibited drips. This material is therefore not satisfactory for the manufacture of tooling or tooling parts intended for the manufacture of aeronautical parts in composite material with improved productivity i.e. with a relatively short inter-pass time as used during testing.

Alloys N° 1 to 4 in Table 1 above have contents of titanium and/or rare earths lower than the lower limits of the ranges corresponding to the alloy of the invention. The inventors found that the walls fabricated from wires made of these alloys also displayed a nonzero number of drips of 7, 5, 3 and 1 respectively. These alloys also are therefore not satisfactory for fabricating tooling or parts of tooling intended for the manufacture of aeronautical parts in composite material with improved productivity.

Additionally, it is observed that alloy N° 1 has a mean coefficient of thermal expansion between 20° C. and 200° C. lower than the desired lower limit for this application. The inventors are of the opinion that this insufficiently high mean coefficient of thermal expansion is due to the fact that the titanium content is lower than the lower limit for the alloy of the invention.

Alloy N° 9 has a titanium content higher than the upper limit of the corresponding range for the alloy of the invention. This wall does not show sagging. On the other hand, it has a mean coefficient of thermal expansion between 20° C. and 200° C. of 3.3×10⁻⁶° C.⁻¹ which is too high for the application under consideration.

Alloys N° 10, 11, 14 and 18 have cobalt contents lower than −1.00×Ni %+36.80% and/or lower than 0.80 weight %. The walls fabricated from wires in these alloys do not show sagging. However, the mean coefficients of thermal expansion of these alloys between 20° C. and 200° C. are too high for the application under consideration.

Alloys N° 16 and 21 have cobalt contents higher than −1.63×Ni %+62.72%. The walls fabricated from wires in these alloys do not show sagging. However, the mean coefficients of thermal expansion between 20° C. and 200° C. of these alloys are 3.1×10⁻⁶° C.⁻¹ and 3.5×10⁻⁶° C.⁻¹ respectively and are too high for the application under consideration.

Alloy N° 22 has a cobalt content higher than 4.20 weight %. The walls fabricated from wires in this alloy do not show sagging. However, the mean coefficient of thermal expansion between 20° C. and 200° C. of this alloy is 2.0×10⁻⁶° C.⁻¹ and is too low for the application under consideration.

On the contrary, the walls made of the alloy of the invention, corresponding to compositions N° 5, 6, 7, 8, 12, 13, 15, 17, 19 and 20 do not show sagging. In addition, these alloys have mean coefficients of thermal expansion between 20° C. and 200° C. of between 2.2×10⁻⁶° C.⁻¹ and 2.9×10⁻⁶° C.⁻¹, and therefore allow the manufacture of tools or parts of tools intended for the manufacture of aeronautical parts in composite material with improved productivity i.e. with a relatively short inter-pass time as used for the tests.

1. Alloy for manufacturing tools intended for manufacturing aeronautical parts made of composite material, the alloy comprising by weight:
$$\begin{matrix}32.6 \% \leq Ni \leq 38. \% \\ 0.8 \% \leq Co \leq 4.2 \%\end{matrix}$$
Co≥−1.00×Ni %+36.80%, where Ni % denotes the Ni content in weight percent in the alloy; and
Co≤−1.63×Ni %+62.72%, where Ni % denotes the Ni content in weight percent in the alloy,
$$\begin{matrix}1. \% \leq Ti \leq 2. \% \\ 0.001 \% \leq rare earths \leq 0.05 \% \\ 0.1 \% \leq Si \leq 0.35 \% \\ 0.15 \% \leq Mn \leq 0.6 \% \\ 0.005 \% \leq C \leq 0.04 \%\end{matrix}$$
the remainder being iron and impurities resulting from the production process.

2. The alloy according to claim 1, wherein the impurities resulting from the production process comprise by weight:
$$\begin{matrix}Ca \leq 0.0015 \% \\ Mg \leq 0.0035 \% \\ Al \leq 0.0085 \% \\ O \leq 0.0025 \% \\ S \leq 0.0035 \% \\ P \leq 0.01 \% \\ B \leq 0.0005 \% \\ Mo \leq 0.1 \% \\ Cr \leq 0.1 \% \\ Cu \leq 0.1 \% \\ Nb \leq 0.1 \% \\ V \leq 0.1 \% .\end{matrix}$$

3. The alloy according to claim 1, wherein the rare earths comprise yttrium, cerium, lanthanum, neodymium, praseodymium, or mixtures thereof.

4. A filler wire made of an alloy according to claim 1.

5. A method for manufacturing a filler wire according to claim 4, the method comprising the following steps:
providing a semi-finished product made of the alloy;
hot processing this semi-finished product to form an intermediate wire; and
transforming the intermediate wire into a filler wire having a smaller diameter than the intermediate wire, said transformation comprising a wire-drawing step.

6. Use of the alloy according to claim 1 to manufacture at least part of a tool intended for the manufacture of an aeronautical part made of composite material.

7. A part or portion of a part made of an alloy according to claim 1.

8. The part or portion of a part according to claim 7, said part or portion of a part being obtained by metal additive manufacturing.

9. The part or portion of a part according to claim 7, the part being a tool intended for the manufacture of an aeronautical part made of composite material.

10. A method for manufacturing a part or portion of a part comprising a step of manufacturing said part or portion of part via a metal additive manufacturing process using, as filler material, a filler wire made of the alloy according to claim 1 and/or a powder of the alloy according to claim 1.

11. The manufacturing method according to claim 10, wherein the additive manufacturing process is chosen from among wire-arc, wire-Laser, wire-electron beam processes, and a hybrid additive manufacturing process combining the technologies of wire-arc and powder-Laser or wire-arc and wire-Laser.

12. Use of the filler wire according to claim 4 as filler wire for a metal additive manufacturing process.

13. A metal powder made of an alloy according to claim 1.

14. A method for manufacturing a metal powder according to claim 13, said method comprising a step of providing a filler wire according to claim 4 and a plasma atomization step of this filler wire to obtain the metal powder.
